(19) United States
(12) Patent Application Publication
(10) Pub. No.: US 2007/0209473 A1
(43) Pub. Date: Sep. 13, 2007

(54) Piston Rod Assembly

(75) Inventors: George Coulter Kennedy, Renfrewshire (GB); Arnaud Fusilier, Anould (FR)

Correspondence Address: LUNDEEN & DICKINSON, LLP, PO BOX 131144, HOUSTON, TX, 77219-1144, US

(73) Assignee: SPICKET VALVES AND PUMPS LIMITED, Kilmacolm (GB)

(21) Appl. No.: 10/595,309

(22) PCT Filed: Oct. 8, 2004
(86) PCT No.: PCT/GB04/04260

§ 371 Date: Dec. 11, 2006

(30) Foreign Application Priority Data
Oct. 8, 2003 (GB) 0323542.1

(51) Int. Cl. F16C 5/00

(52) U.S. Cl. 74/593

(57) ABSTRACT

A piston rod assembly for coupling between a power end and a fluid end of a high pressure reciprocating pump. Part cylindrical members are clamped together via pistons arranged orthogonally to the rod axis. The members grip the power and fluid o end components in a knuckle joint or ball and socket. By providing orthogonal loading, a large contact area is obtained between the members and the components, which gives a mechanical advantage in keeping the parts together even when a maximum reciprocating force is applied by the pump.

This invention relates to high pressure reciprocating pumps such as those used to pump drilling mud in the oil production industry, including those pumps commonly referred to in the industry as mud and slush pumps. In particular, the invention relates to a piston rod assembly, suitable for rapid replacement between a power end and a fluid end of a reciprocating pump.

It is necessary with high pressure reciprocating pumps to replace the piston or other dynamic component with relative regularity and it is therefore advantageous if this task can be performed quickly and easily. Typical quick release piston rod assemblies, such as those disclosed in GB 2,190,170 and U.S. Pat. No. 5,904,701, have axially arranged links to the power and fluid ends, held in place by radial pins. Tension is then applied to the pins via axial pistons to couple the fluid and power ends together.

A disadvantage of these assemblies is that connectors with suitably sized apertures must be arranged at each of the power and fluid ends. The use of radial pins, to which longitudinal tension is applied, provides weak points on the assembly which can be prone to fracture during high reciprocation. A further disadvantage of these assemblies is that the relative angle between the power end and fluid end must be taken into account when positioning the assembly.

It is an object of the present invention to provide a piston rod assembly which obviates at least some of the disadvantages of the prior art.

According to the present invention there is provided a piston rod assembly, for coupling between a power end and a fluid end of a high pressure reciprocating pump, the assembly comprising one or more clamping members arranged relative a rod axis between the power end and the fluid end, each member having a first end adapted to grip a power end component and a second end adapted to grip a fluid end component, at least one member including one or more tensioning means, wherein said tensioning means comprise a piston to provide a load in said tensioning means orthogonal to said first rod axis and thereby secure said components against release.

Preferably the clamping members are part cylindrical bodies which when arranged on the rod axis provide a substantially cylindrical body. Preferably there are two clamping members, an upper clamping member and a lower clamping member.

Preferably the first and second ends include a contact face parallel to the rod axis on an inner surface.

Preferably the face provides a recess on the inner surface in which a portion of the power end component or fluid end component may be located such that the component is gripped and held when the clamping members are brought together by the tensioning means. Advantageously each component end and the first/second end provide a knuckle joint. Alternatively, they may provide a ball and socket.

This clamping is obtained without any need of relative angle position between the power end component and the fluid end component. Further when the load is applied on the rod axis, the large contact area between the faces and the components provides a large mechanical advantage thus facilitating a large force to solidly assemble the parts together even when a maximum reciprocating force is provided by the pump.

Preferably each piston is slideable within an hydraulic cylinder. More preferably each piston includes a stem adapted to receive a nut or a lock. Preferably said stems extend from one clamping member through an aperture in an adjacent clamping member. The nut may then engage the stem to couple the clamping members. Preferably also a spring is arranged within the hydraulic cylinder to tension the said stem. Advantageously, the assembly includes non-rotational means for preventing rotation of said stem. The non-rotational means may be a pin locating in a matching recess arranged parallel to the stem.

Preferably a space is defined between a base of the cylinder and a base of the piston for accommodating hydraulic fluid. Preferably the assembly includes a fluid inlet port to permit the input of hydraulic fluid to the cylinder. Advantageously a chamber may be included in each member to provide a common feed for hydraulic fluid to all cylinders within the member.

An embodiment of the present invention will be described by way of example, with reference to the accompanying drawings, in which:

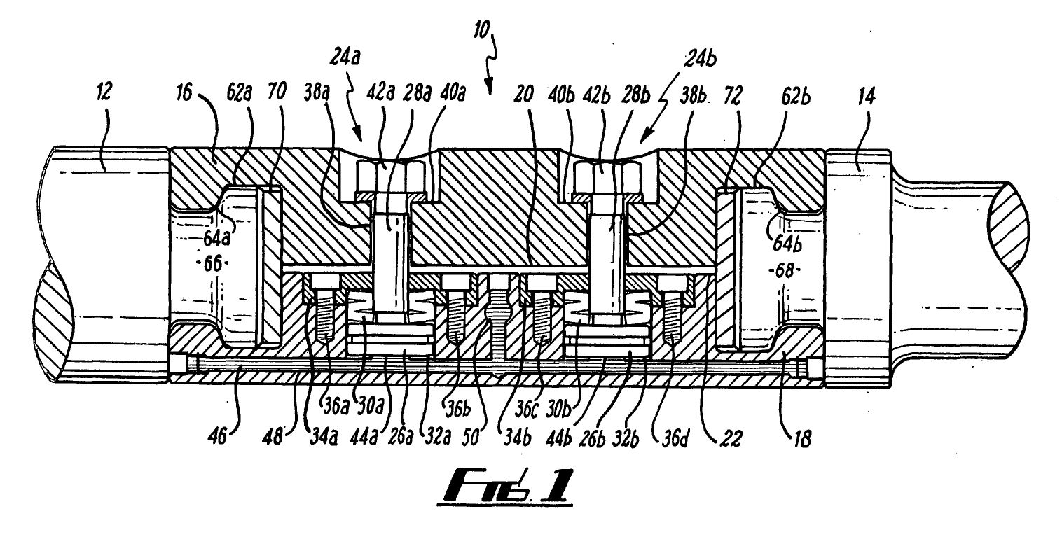

FIG. 1 is a sectional side elevation of a piston rod assembly, according to an embodiment of the present invention;

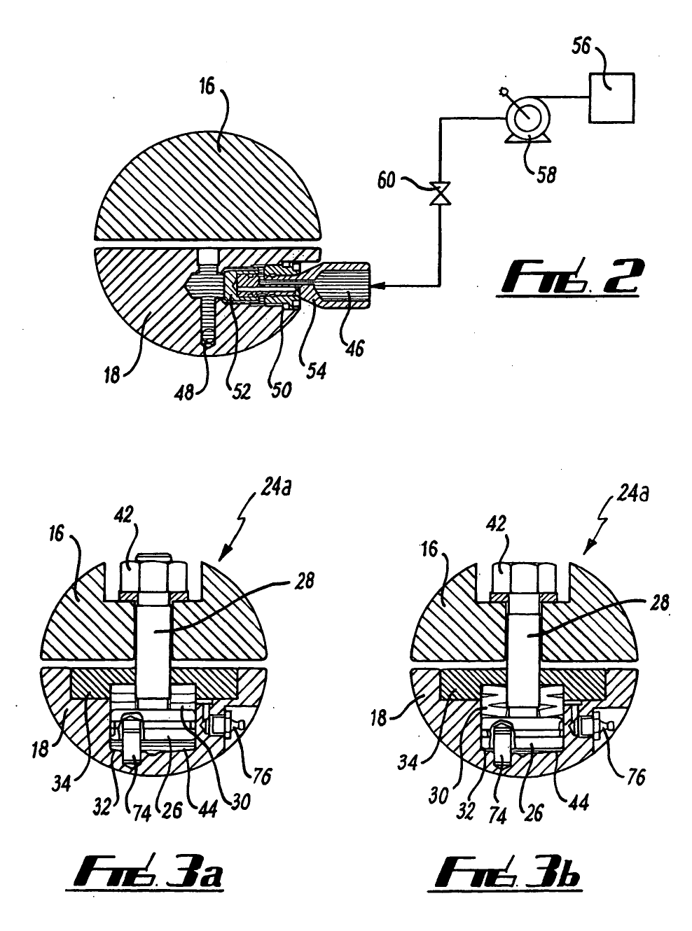

FIG. 2 is a sectional schematic view of a fluid inlet port of a piston rod assembly according to an embodiment of the present invention; and

FIGS. 3a & 3b are sectional views of tensioning means in first (3a) and second (3b) operating positions.

Reference is initially made to FIG. 1 of the drawings which illustrates a piston rod assembly, generally indicated by reference numeral 10, according to an embodiment of the present invention. Piston rod assembly 10, is located between a power end component 12 and a fluid end component 14. The components 12,14 form parts of a high pressure reciprocating pump as will be recognised by those skilled in the art. In particular the piston rod assembly 10 can be used in a high pressure reciprocating oilfield mud pump.

The piston rod assembly 10 may be considered as a clamping link by virtue of its purpose i.e. to provide a releasable coupling between the power end component 12 and the fluid end component 14 which is secure during the high reciprocating force applied by the pump. Assembly 10 comprises two half-cylindrical clamps 16,18. Each clamp 16,18 has an inner planar surface 20,22 respectively. The surfaces 20,22 are arranged on and lie parallel to the rod axis. The rod axis is a central line located between the end components 12,14.

The piston rod assembly 10 includes two tensioning modules 24a,b to connect the clamps 16,18. Each tensioning module includes a piston 26a,b, a piston stem 28a,b, and a disc spring stack 30a,b arranged within a cylindrical housing 32a,b with the lower clamp 18. These elements 28,30,32 are all disposed orthogonally to the rod axis of the assembly 10. Covers 34a,b, held in place by screws 36a-d, close the housings 32a,b retaining the spring force. The upper clamp 16 includes apertures 38a,b through which extend the stems 28a,b from the lower clamp 18. Each aperture 38 widens to provide a lip 40a,b parallel to the rod axis. A nut 42a,b is screwed to the stem 28a,b and may be tightened against the lip 40a,b.

Below each piston 26a,b in a space defined by the base of the piston 26a,b and the base of the housing 32a,b is a fluid chamber 44a,b. Hydraulic fluid 46 may enter this chamber 44 and exert a force upon the piston 26a,b. The chambers are connected to a fluid line 48 located along the length of the assembly 10. The fluid line 48 is sealed, but includes an inlet port 50 illustrated in FIG. 2.

Referring to FIG. 2, the inlet port 50 is now seen in a perpendicular aspect. Like parts to those of FIG. 1 have been given the same reference numeral to aid clarity. A female connector 52 is located with the port 50. By inserting a male connector 54 into the female connector 52 pressurising hydraulic fluid 46 can be inserted into the fluid line 48. It will be recognised by those skilled in the art that the fluid 48 may be supplied from a reservoir 56, utilising a pump 58, through a check valve 60. The connectors 52,54 are preferably quick release connectors and the male connector 54 is a differential pressure fastening, which avoids the need to screw in any device, thus making the task of pressurising and releasing very fast.

Returning to FIG. 1, on the inner surface 20,22 are arranged recesses 62a,b. When the clamps 16,18 meet the recesses 62a,b form circumferential grooves around the inner surface 20,22 equidistantly from the rod axis. Each component end 12,14 includes a protrusion 66,68 which may be likened to a door knob or knuckle in profile. Each protrusion 66,68, lies within a recess 62a,b and a large contact surface area 64a,b is provided between the protrusion 66,68 and the inner surface 20,22. Additionally as each recess 62a,b has an angled surface facing toward the ends 12,14 respectively, the protrusions 66,68 are effectively gripped by the clamps 16,18. To aid the fitting of each protrusion 66,68 into each recess 62a,b, bearing pads 70,72 are located at the distal ends of the protrusions 66,68. The bearing pads 70,72 may be formed of a material which provides some give and has a relatively high elastic modulus.

Reference is now made to FIGS. 3a and 3b. Like parts to those of FIGS. 1 and 2 have been given identical reference numerals to aid clarity. These Figures show operating positions of the assembly and will be described fully hereinafter. Additionally these figures illustrate further features of the assembly 10. An anti-rotation pin 74 is located within the base of the piston 26 and extends into the base of the housing 32. The anti-rotation pin 74 prevents the piston 26 rotating during movement of the nut 42. Also included in the assembly 10 is a grease nipple 76 as is known in the art. The grease nipple 76 fills grease into the disc spring stack 30 to protect the stack 30 from rust.

In use, the lower clamp 18 including the tensioning modules 24 are located against protrusions 66,68 of a power end component 12 and a fluid line component 14 of a pump. The protrusions 66,68 rest in the recesses 62a,b. the upper clap 16 is then placed over the lower clamp 18 such that the stems 28a,b locate through the apertures 38a,b respectively. Nuts 42a,b are located on the stems 28a,b and hand tightened to align the protrusions 66,68 against the surface 64a,b. This process can be done without the need to ensure that the end components 12,14 are perfectly aligned as tightening the nuts 42 will bring the ends 12,14 into alignment. Fluid 48 is then introduced to the line 46. Pressure will consequently build up in the chambers 44a,b and the pistons 26a,b will be forced upwards by a short distance, orthogonal to the rod axis. This is illustrated in FIG. 3a. The nuts 42a,b are given freedom to be tightened by further rotation along the stems 28a,b towards the lips 40a,b. It should be noted that the apparatus and method described herein allows the nuts 40a,b to be tightened by hand by means of a socket wrench. It will be appreciated that this is a considerable advantage over the requirement of using heavy tools.

When fluid pressure in the chambers 44a,b is released by removal of the fluid 46, the pistons 26a,b are pushed outwards towards the base of the housing 30a,b by the spring stacks 30a,b. This places in shear the clamps 16,18 and the bearing pads 70,72. The end components 12,14 are now securely attached to the clamping link or assembly 10. This is illustrated in FIG. 3b. Further with the load applied on the rod axis, the large contact area 64a,b between the surfaces 20,22 and the components 66,68 provides a large mechanical advantage thus facilitating a large force to solidly assemble the parts together even when a maximum reciprocating force is provided by the pump.

These steps may be repeated any number of times to release or couple the assembly 10 between the ends 12,14.

The principal advantage of the present invention is that by applying a force orthogonally to the rod axis a greater securing force is provided to clamp the assembly to the component ends. This also dispenses with the need to provide apertures through the end components for locking pins.

A further advantage of the present invention is that in bringing the clamps together to grip the ends, the ends need not be in perfect alignment initially. Additionally any dirt which becomes trapped between the clamps, will merely provide a spacing which can be made up be the stacking springs. In this way the dirt will not cause loosening of the clamps during reciprocation of the pump in use.

A yet further advantage of the present invention is that the assembly can be quickly made up without the need for heavy tool to tighten the nuts.

It will be appreciated by those skilled in the art that various modifications may be made to the invention herein described without departing from the scope thereof. For example, any number of tensioning modules may be incorporated, as could numbers of clamps depending on the shape of the protrusions at each of the ends. Additionally, though spring stacks have been used to provide tension in the piston housings, other elastic members could be substituted. Further, a water flushing pipe as is known in the art may be incorporated to remove dirt and provide lubrication and cooling to the system.

1. A piston rod assembly for coupling between a power end and a fluid end of a high pressure reciprocating pump, the assembly comprising one or more clamping members arranged relative to a rod axis between the power end and the fluid end, each member having a first end adapted to grip the power end component, and a second end adapted to grip the fluid end component, and at least one member including one or more tensioning devices, wherein said tensioning device comprises a piston to provide a load in said tensioning device orthogonal to said rod axis and thereby secure said components against release.

2. A piston rod assembly as claimed in claim 1, wherein, the clamping members are part cylindrical bodies which when arranged on the rod axis provide a substantially cylindrical body.

3. A piston rod assembly as claimed in claim 1 wherein, there are two clamping members, an upper clamping member and a lower clamping member.

4. A piston rod assembly as claimed in claim 1 wherein, the first and second ends include a contact face parallel to the rod axis on an inner surface.

5. A piston rod assembly as claimed in claim 4, wherein each face provides a recess on the inner surface in which a portion of the power end component or fluid end component is located such that the component is gripped and held when the clamping members are brought together by the tensioning device.

6. A piston rod assembly as claimed in claim 1 wherein each component end and the first/second end provide a knuckle joint.

7. A piston rod assembly as claimed in claim 1 wherein each component end and the first/second end provide a ball and socket.

8. A piston rod assembly as claimed in claim 1 wherein each piston is slideable within an hydraulic cylinder.

9. A piston rod assembly as claimed in claim 1 wherein each piston includes at least one stem adapted to receive a nut or a lock.

10. A piston rod assembly as claimed in claim 9 wherein each stem extends from one clamping member through an aperture in an adjacent clamping member, and wherein a nut engages the stem to couple the clamping members.

11. A piston rod assembly as claimed in claim 9 wherein a spring is arranged within the hydraulic cylinder to tension the said stem.

12. A piston rod assembly as claimed in claim 9 wherein the assembly includes non-rotational means arrangement for preventing rotation of said stem.

13. A piston rod assembly as claimed in claim 12 wherein the non-rotational arrangement is a pin locating in a matching recess arranged parallel to the stem.

14. A piston rod assembly as claimed in claim 8 wherein a space is defined between a base of the cylinder and a base of the piston for accommodating hydraulic fluid.

15. A piston rod assembly as claimed in claim 8 wherein the assembly includes a fluid inlet port to permit the input of hydraulic fluid to the cylinder.

16. A piston rod assembly as claimed in claim 15 wherein a chamber is included in the/each member to provide a common feed for hydraulic fluid to all cylinders within the member.
